(19) United States
(12) Patent Application Publication
(10) Pub. No.: US 2010/0098047 A1
(43) Pub. Date: Apr. 22, 2010

(54) Setting a data rate of encoded data of a transmitter

(75) Inventors: Xiaoming Zhou, Sunnyvale, CA (US); Patrick Worfolk, Campbell, CA (US); Sujai Chari, Burlingame, CA (US)

Correspondence Address: Tzero, P.O. Box 641867, San Jose, CA, 95164-1867, US

(73) Assignee: Tzero Technologies, Inc.

(21) Appl. No.: 12/288,504

(22) Filed: Oct. 21, 2008

(51) Int. Cl. H04J 3/00

(52) U.S. Cl. 370/345

(57) ABSTRACT

Embodiments for setting a data rate of encoded data of a transmitter are disclosed. One method includes determining a physical layer transmission rate based on a transmission link quality of a link, estimating a transmission throughput that can be transmitted over the link ensuring a level of Quality of Service (QOS) requirement, and the transmitter adjusting the data rate of the encoded data based on the estimated transmission throughput.

### FIELD OF THE DESCRIBED EMBODIMENTS

The described embodiments relate generally to data communications. More particularly, the described embodiments relate to a method and apparatus for setting a data rate of encoded data of a transmitter.

### BACKGROUND

Wireless networking connects one or more wireless devices to other wireless devices without a direct electrical connection, such as a copper wire or optical cable. Wireless devices communicate data, typically in the form of packets, across wireless networks and open a “data” or “communication” channel on the networks such that the device can send and receive data packets.

The transmission links formed by the communication channels typically have a link quality that varies over time. The variation in quality can cause the amount of data (throughput) that can be transmitted over the transmission links to vary with time. If, for example, the data being transmitted is streaming video data, then to some extent the varying data throughput can be accommodated by data buffers within the transmitter. However, if the link quality varies too much, then the buffers can overflow, causing packets of data to be lost, or the buffers can underflow (under utilization) causing, for example, streaming video data to have sub-optimal quality.

FIG. 1 shows an example of a network of wireless devices. A transmitting device (such as, transceiver 110) may be transmitting, for example, streaming video to each of multiple receivers (such as, transceivers 120, 122, 124). However, the different links (Link1, Link2, Link3) between the transceivers can have different link qualities, and therefore, different data throughput capacities. As shown, multiple of the links (Link1, Link2) can share a common steam (Stream1) or at least one of the links (Link3) can have a different steam (Stream2).

It is desirable to have methods of adjusting rates of encoding data based upon a quality of a transmission link.

### SUMMARY

An embodiment includes a method of setting a data rate of encoded data of a transmitter. The method includes determining a physical layer transmission rate based on a transmission link quality of a link, estimating a transmission throughput that can be transmitted over the link ensuring a level of Quality of Service (QOS) requirement, and the transmitter adjusting the data rate of the encoded data based on the estimated transmission throughput.

Another embodiment includes a method of setting a data rate of encoded data of a transmitter. The method includes determining a physical layer transmission rate based on a transmission link quality of a link, and adjusting the data rate of the encoded data based on the physical layer transmission rate, a transmission packet size, and a transmission reservation allocation.

Another embodiment includes a transmitter. The transmitter includes means for determining a physical layer transmission rate based on a transmission link quality of a link, means for estimating a transmission throughput that can be transmitted over the link ensuring a level of Quality of Service (QOS) requirement, and means for adjusting the data rate of the encoded data based on the estimated transmission throughput.

Another embodiment includes a method of setting a data rate of encoded video data for a UWB wireless transmitter. The method includes determining a physical layer transmission rate based on a transmission link quality of a link, estimating a transmission throughput that can be transmitted over the link ensuring a level of Quality of Service (QOS) requirement, and the UWB wireless transmitter adjusting the data rate of the encoded video data based on the estimated transmission throughput.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a network of wireless devices.

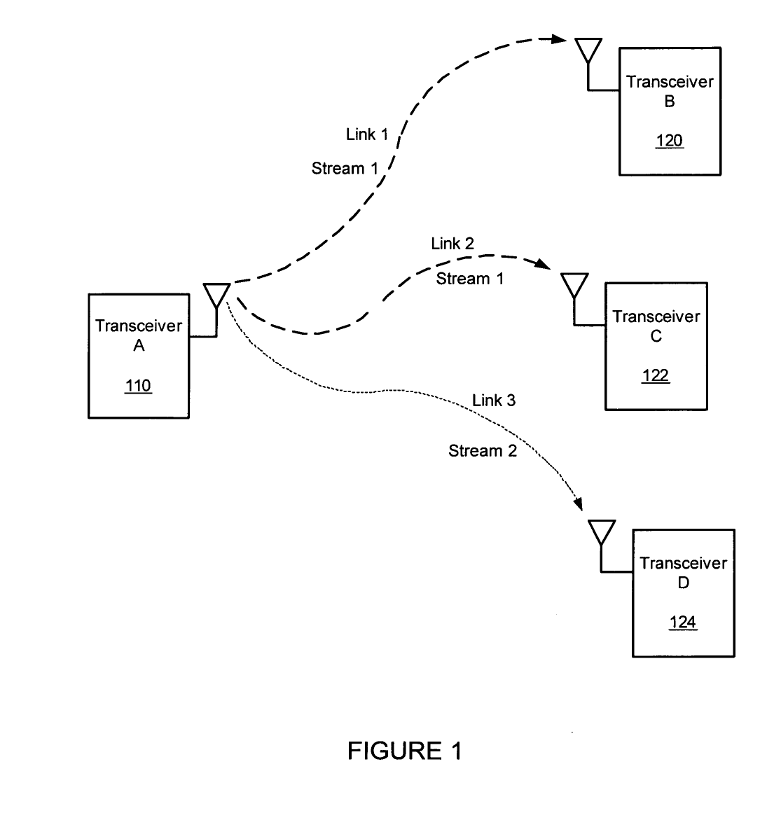

FIG. 2 shows an example of transmitter that includes an encoder, and a transmission link that has a varying link quality.

FIG. 3 shows an example of transmitter that includes an encoder, and a transmission link that has a varying link quality, and further includes processing for adjusting a data rate of encoded data of the transmitter based at least partially on the link quality.

FIG. 4 shows an example of transmitter that includes an encoder, and a transmission link that has a varying link quality, and further includes buffers and buffer threshold detector that provide additional adjustment of the data rate of encoded data of the transmitter.

FIG. 5 shows a flow chart of step of an example of a method of setting a data rate of encoded data of a transmitter.

FIG. 6 shows a flow chart of step of an example of a method of setting a data rate of encoded data of a transmitter.

FIG. 7 shows an example of transmitter that includes an encoder, and a transmission links between multiple wireless transceivers in which the links each include a varying link quality.

### DETAILED DESCRIPTION

The embodiments described include methods and apparatuses for setting a data rate of encoded data of a transmitter.

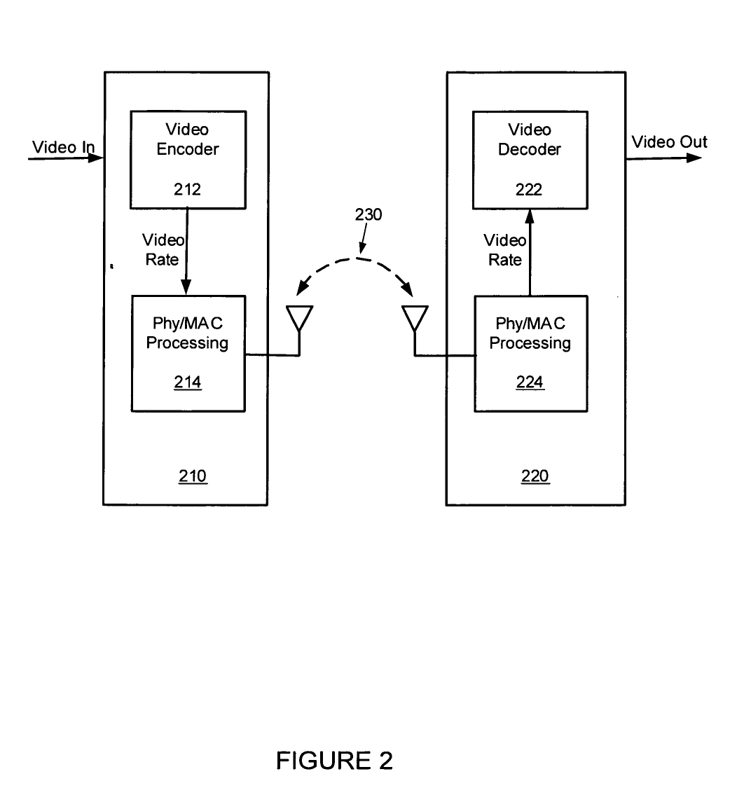

FIG. 2 shows an example of transmitter 210 that includes a video encoder 212, and a transmission link 230 that has a varying link quality. The transmission link 230 provides a data path (for example, streaming video) between the transmitter 210 and the receiver 220. The receiver 220 typically includes processing 224 and video decoder 222.

The varying quality of the link 230 causes the data throughput of the link 230 to vary. However, if the video data streaming from the video encoder 212 does not vary, a buffering or queuing problem can occur within the transmitter 210. More specifically, buffers can be located between the video encoder 212 and Phy/MAC processing 214 within the transmitter 210, which can introduce queuing delays that can degrade the streaming video. Additionally or alternatively, the buffering can become over-loaded or starved depending upon the variations of the link quality.

Over-loading the buffers can lead to overflow, which can cause a loss of video data. Lost video data can be particularly undesirable. That is, due to the nature of streaming video data, retransmitting the video data is typically not an option.

Under-loading the buffers can cause under utilization of the wireless link. That is, the streaming video data may not be transmitted at as high a rate as the wireless link allows. As a result, the streaming video data may be compressed more than it would if the under-loading condition did not occur. The compression can include, for example, dropping frames, or reducing the resolution of the video, both of which reduce the quality of the video.

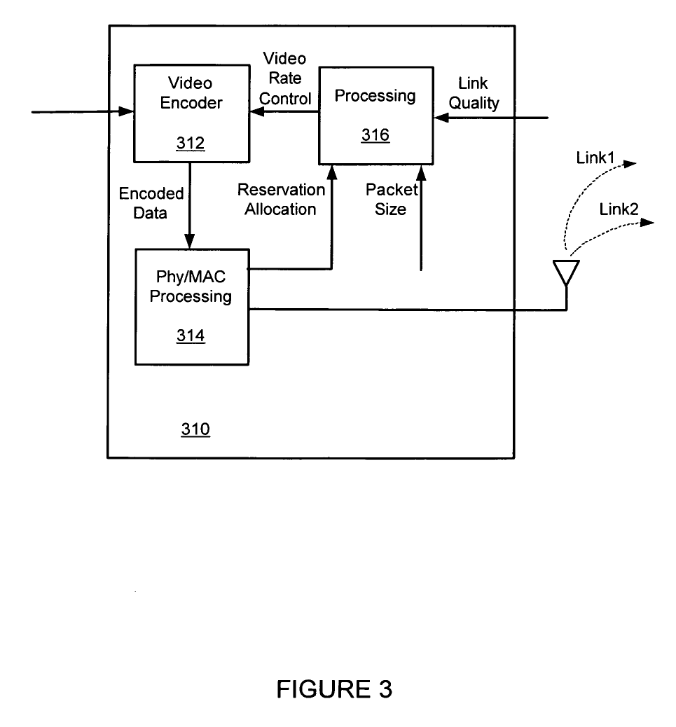

FIG. 3 shows an example of transmitter 310 that includes an encoder 312, and at least one transmission link (link1, link2) that has a varying link quality, and further includes processing for adjusting a data rate of encoded data of the transmitter 310 based at least partially on the link quality. The transmitter 310 includes an encoder (shown as, for example, a video encoder) 312 that generates a stream of encoded data.

Embodiments of setting a data rate of encoded data of the transmitter 310 include determining a physical layer transmission rate based on a transmission link quality of at least one of the links (Link1, Link2). A transmission throughput that can be transmitted over the at least one of the links (Link1, Link2) ensuring a level of Quality of Service (QOS) requirement is estimated. The transmission throughput can be estimated based on, for example, the worst quality link or an average of the qualities of multiple links. The data rate of the encoded data is adjusted based on the estimated transmission throughput.

For one embodiment, the physical layer transmission rate is determined by the transmitter 310 itself. More specifically, the transmitter 310 can monitor ACKs (acknowledgements) to data packets. That is, the transmitter transmits data packets to the receiver. The receiver transmits back to the transmitter an ACK if a data packet is successfully received by the receiver. Therefore, the transmitter can estimate the number or percentage of data packets that successfully made it across the wireless link between the transmitter and the receiver based on the ACK received by the transmitter. By monitoring the ACKs the transmitter can determine which packets where successfully received, and therefore, the transmitter 310 can estimate the quality of the link between the transmitter 310 and a receiver. It should be understood, however, that the quality of the link can be determined any number of different ways.

It is to be understood that alternative methods can be used for estimating the quality of the link or links. Other methods include ACK statistics, packet error rate (PER) measurements, predictions or estimates, and/or reservation availability based on a density of wireless transceivers. If there are many wireless devices located in an area, each device has less access to available channels. The fraction of the channels available for communication between pairs of devices can be combined with the estimate of the previously mentioned link quality and packet size to estimate the transmission throughput.

Once the quality of one or more links of the transmitter 310 have been determined, a transmission throughput for the one or more of the links can be estimated that ensures a level of Quality of Service (QoS). Several different methods can be used to estimate the transmission throughput. For example, the transmission throughput can be estimated as a function of, for example, the physical layer transmission rate, a transmission packet size, and a transmission reservation allocation. Through, for example, experimentation and analysis, a look up table can be generated allowing the transmission throughput to be estimated, for example, based on the physical layer transmission rate.

Quality of service is the ability to provide different priority to different applications, users, or data flows, or to guarantee a certain level of performance to a data flow. For example, a required bit rate, delay, jitter, packet dropping probability and/or bit error rate may be guaranteed. Quality of service guarantees are important if the network capacity is insufficient, especially for real-time streaming multimedia applications such as voice over IP, online games, streams to HDTV and IP-TV, since these often require fixed bit rate and are delay sensitive, and in networks where the capacity is a limited resource, for example in cellular data communication. For wireless links, capacity can also vary because of fluctuations in wireless link qualities.

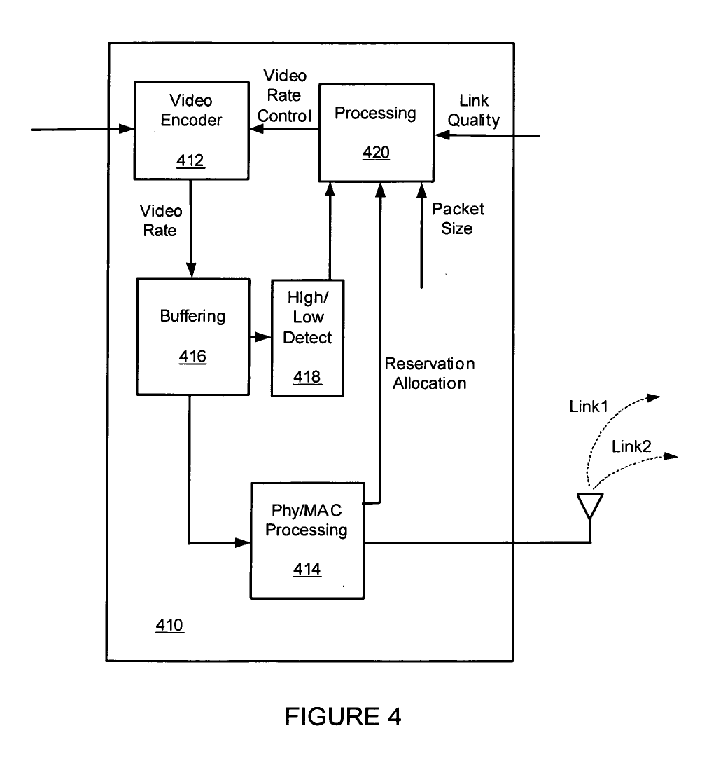

FIG. 4 shows an example of transmitter 410 that includes an encoder 412, and a transmission link (Link1, Link2) that has a varying link quality. This embodiment additionally includes the previously mentioned buffering 416. The buffering 416 is shown as being located between the encoder 412 and the Phy/MAC processing 414. The buffering 416 can be used to at least partially mitigate differences between the transmission throughput and the data rate of encoded data.

To prevent the buffering 416 from introducing excessive queuing delays, high/low detectors 418 can detect whether the buffering causes a buffering queuing delay to exceed a first predetermined threshold. If the buffering queuing delay does exceed the first predetermined threshold, then processing 420 of the transmitter 410 adaptively decreases the data rate of the encoded data. By decreasing the data rate of the encoded data, the size of the queue of the buffering 416 should decrease. A more specific embodiment includes varying the first predetermined threshold based on at least one of a stability and accuracy of the estimated transmission throughput.

The detector can also detect when the buffering queuing delay falls below a second predetermined threshold. If detected, the processing 420 can increase the data rate of the encoded data.

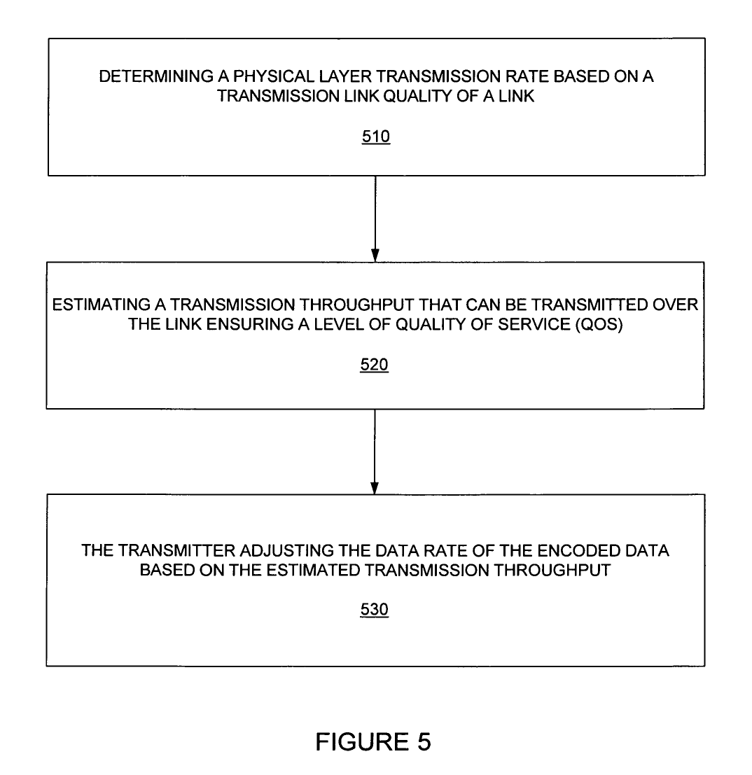

FIG. 5 shows a flow chart of step of an example of a method of setting a data rate of encoded data of a transmitter. A first step 510 includes determining a physical layer transmission rate based on a transmission link quality of a link. A second step 520 includes estimating a transmission throughput that can be transmitted over the link ensuring a level of Quality of Service (QOS) requirement. A third step 530 includes the transmitter adjusting the data rate of the encoded data based on the estimated transmission throughput.

Estimating a transmission throughput that can be transmitted over the link ensuring a level of Quality of Service (QOS) requirement can include calculating an estimated transmission throughput based on the physical layer transmission rate, a transmission packet size, and a transmission reservation allocation.

An embodiment includes adapting the transmission packet size. The transmission packet size can be adjusted, for example, to adjust the data rate of the encoded data.

The transmission reservation allocation determines the number of time slots reserved, and determines the locations of the time slots within, for example, a superframe.

As previously described, the transmitter can estimate the transmission throughput based an ACK policy. The ACK policy can include, for example, a No-ACK policy, an immediate ACK policy, or a block ACK policy. The No-ACK policy can include the recipients not acknowledging transmissions, and the transmitters treating the transmissions as successful without regard for the actual result. The immediate ACK policy can include the addressed recipients returning an immediate acknowledgement after correct reception. The block ACK policy can include the addressed recipient keeping track of the frames received with the policy until requested to respond with a block acknowledgement.

The transmitter can calculate the estimated transmission throughput based on the physical layer transmission rate, a transmission packet size, and a transmission reservation allocation by the transmitter accessing the estimated transmission throughput from a look up table.

For an embodiment, the look up table is dynamically generated, and can be continuously updated. The look up table can be determined based upon a duration of a super-frame (for example, a UWB super-frame), the reservation allocations or size, and/or the packet size. Other embodiments include a duration of less than a super-frame.

Alternatively, the transmitter calculates an estimated transmission throughput based on the physical layer transmission rate (PLTR), a transmission packet size, and a transmission reservation allocation using a predetermined function. One example of a function includes:

Throughput=(PLTR)×((Payload Size/Packet Size))×(FCR)×(1−margin),

wherein FCR is the fraction of the channel reserved by the transmitter, and the margin can be included to account for packet error rate (PER), inter-packet spacing and/or implementation latencies.

This functional throughput estimation function can be used to generate the entries of the previously described look up table.

As previously shown and described, the encoded data can be buffered. It is generally desirable to avoid queuing delays within the buffer that are large enough to compromise the quality of streaming encoded video data. One embodiment includes detecting if a buffering queuing delay exceeds a first predetermined threshold, and the transmitter adaptively decreasing the data rate of the encoded data if the buffering queuing delay exceeds the first predetermined threshold. By decreasing the data rate of the encoded data, the size of the queue of the buffer should decrease.

A more specific embodiment includes varying the first predetermined threshold based on at least one of a stability and accuracy of the estimated transmission throughput. If the link capacity is varying rapidly, a more conservative data rate of the encoded data can be selected based on the variance. If the accuracy is limited, then a more conservative value of conservative data rate of the encoded data can be selected. An embodiment includes the accuracy being dependent, for example, on PER estimates of the link.

It should be understood that as an alternative to queuing delay, a queue size (that is, the number of packets within the buffer(s)) can be used to adaptively adjust the data rate of the encoded data. The following embodiments that utilize queuing delay can alternatively be implemented utilizing queuing size or buffer size.

An embodiment includes the transmitter adaptively updating the data rate of the encoded data based on an average of the queuing delay (or alternatively, queuing size) of the encoded data. This can include, for example, comparing an average of the queuing delay with the queuing delay of a half buffer. If the average queuing delay is less, then the data rate of the encoded data is increased. If the average queuing delay is more, then the data rate of the encoded data is decreased.

Another embodiment includes detecting if a buffering queuing delay (or alternatively, queuing size) falls below a second predetermined threshold, and the transmitter adaptively increasing the data rate of the encoded data to the estimated transmission throughput if the buffering queuing delay falls below the second predetermined threshold. A more specific embodiment includes varying the second predetermined threshold based on at least one of a stability and accuracy of the estimated transmission throughput.

As previously described, the qualities of the transmission links can vary over time. Accordingly, an embodiment includes the transmitter (or receiver) re-determining the physical layer transmission rate over time. An embodiment includes the transmitter determining the physical layer transmission rate once per a UWB frame.

The previously described transmission reservation allocation over time can be updated. This is desirable and/or required because reservation allocations change as devices within the wireless network are activated and/or deactivated.

For an embodiment the encoded data comprises video data, and the data rate of the video data is at least partially adjusted by a selection of compression technique. An embodiment includes selecting the compression technique of the video data based on at least one of a variability of the transmission link quality, an accuracy of estimates of transmission link quality, a speed at which the transmission link quality is determined, and a number of devices which are sharing a channel. As previously described, the compression of the video data can come in different forms. For example, one method of compression includes changing the resolution of the video, another method includes skipping frames of the video of the video data. Changing the resolution may be selected if the estimate of the transmission link quality is considered reliable. For example, the changing the resolution may be selected if the variance of the transmission link quality is lower (below) than a low variance threshold. Skipping frames of video may be selected if, for example, the variance of the transmission link quality is higher (above) than a high variance threshold.

In some situations, the transmitter is transmitting a single encoded data to multiple receivers, or multiple nodes (some of which are multiple wireless hops away) of a mesh network. Accordingly, an embodiment includes determining a plurality of physical layer transmission rates based on transmission link qualities of a plurality of links, estimating a plurality of transmission throughputs that can be transmitted over a plurality of links ensuring a level of Quality of Service (QOS) requirements, and the transmitter adjusting the data rate of the encoded data based on the estimated plurality of transmission throughputs.

In other situations, the transmitter is transmitting multiple encoded data streams to multiple receivers. Accordingly, an embodiment includes determining a plurality of physical layer transmission rates based on transmission link qualities of a plurality of links, estimating a plurality of transmission throughputs that can be transmitted over a plurality of links ensuring a level of Quality of Service (QOS) requirements, and the transmitter adjusting data rates (that is, multiple data rates) of the encoded data based on the estimated plurality of transmission throughputs. It is to be understood that the different links can be specified to have different levels of QOS.

The links can be multiple links between the transmitter and multiple receivers. That is, a single transmitter (transceiver) can have multiple links between the transmitter and multiple receivers within one wireless hop. Alternatively, the multiple links can be multiple links formed by multiple wireless hops of a wireless mesh network. That is, some of the links can be multiple wireless hops away from the transmitter.

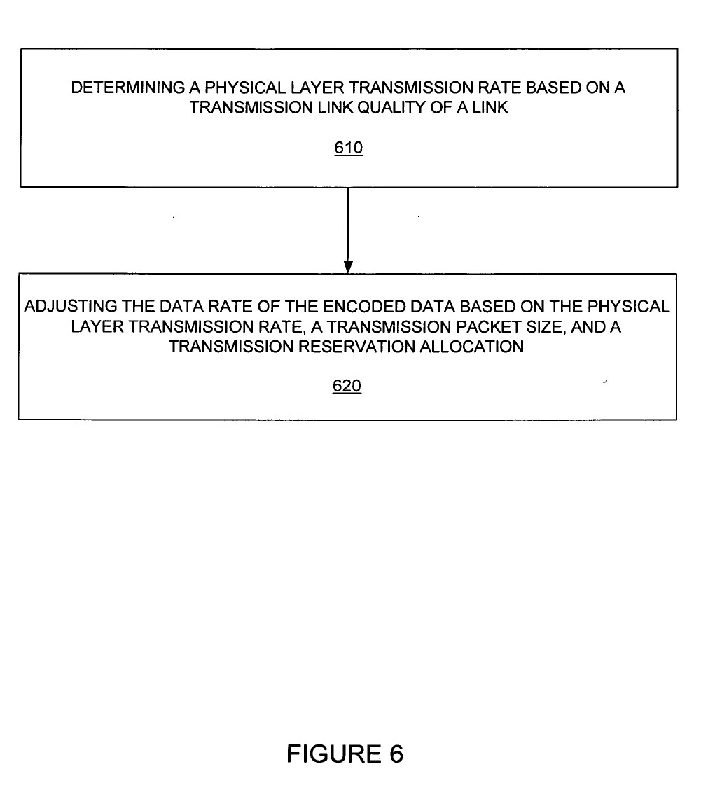

FIG. 6 shows a flow chart of step of an example of a method of setting a data rate of encoded data of a transmitter. A first step 610 includes determining a physical layer transmission rate based on a transmission link quality of a link. A second step 620 includes adjusting the data rate of the encoded data based on the physical layer transmission rate, a transmission packet size, and a transmission reservation allocation.

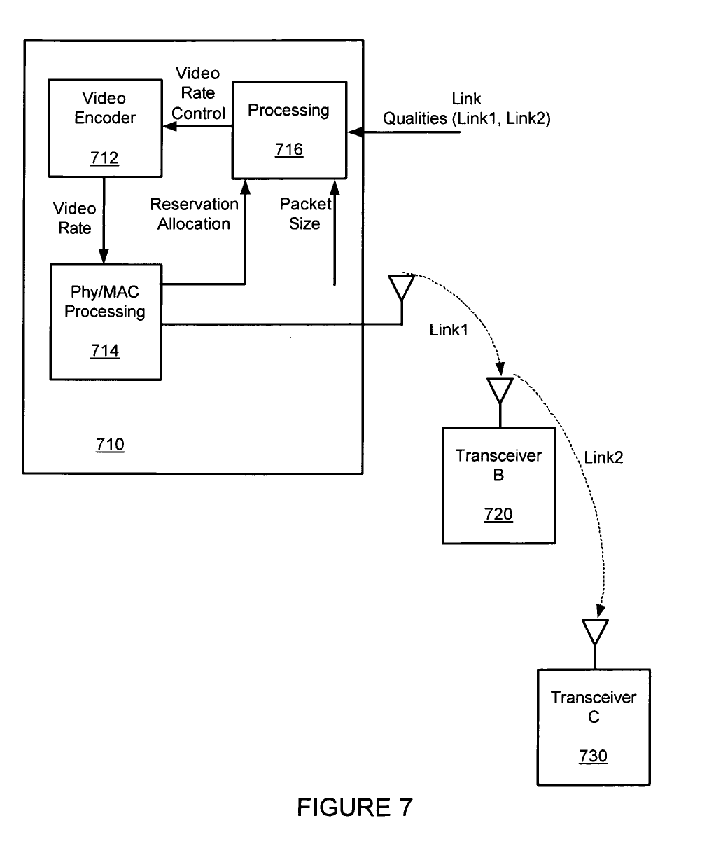

FIG. 7 shows an example of transmitter 710 that includes an encoder 712, and transmission links (Link 1, Link2, Link3) between multiple wireless transceivers 710, 720, 730 in which the links (Link1, Link2, Link3) each include a varying link quality. Each of the multiple wireless transceivers 710, 720, 730 can include similar embodiments for setting the data rate of encoded data of the transceiver.

Accordingly, an embodiment includes determining a plurality of physical layer transmission rates based on transmission link qualities of a plurality of links (Link1, Link2, Link3), estimating a plurality of transmission throughputs that can be transmitted over a plurality of links (Link1, Link2, Link3) ensuring a level of Quality of Service (QOS) requirements, and the transmitter adjusting data rate (that is, a single data rate) of the encoded data based on the estimated plurality of transmission throughputs. The data rate of the encoded data may be selected, for example, based on the worst quality link having the lowest estimated data throughput. If, for example, there is no explicit QOS requirement per link, then in a multi-hop configuration (mesh network), the encoded data rate can be based on, for example, the worst quality link of the multiple wireless hops.

The various components used to adjust the data rate of the encoded data can occur on multiple time scales. That is, for example, the physical layer transmission rate can be determined once per a UWB frame, or about once every 100 microseconds or more. The transmission reservation allocation can be selected once every multiple of a superframe, or about 64 milliseconds or multiples of. A data rate of encoded streaming video can be selected once per a video frame, or about once every 16 milliseconds. Compression, for example, of the streaming video data can be relatively easy to adjust once per video frame.

Although specific embodiments have been described and illustrated, the embodiments are not to be limited to the specific forms or arrangements of parts so described and illustrated.

What is claimed:

1. A method of setting a data rate of encoded data of a transmitter, comprising:
determining a physical layer transmission rate based on a transmission link quality of a link;
estimating a transmission throughput that can be transmitted over the link ensuring a level of Quality of Service (QOS) requirement;
the transmitter adjusting the data rate of the encoded data based on the estimated transmission throughput.

2. The method of claim 1, wherein estimating the transmission throughput comprises calculating an estimated transmission throughput based on the physical layer transmission rate, a transmission packet size, and a transmission reservation allocation.

3. The method of claim 2, wherein the estimated transmission throughput is additionally based ACK policy.

4. The method of claim 2, wherein the transmitter calculating an estimated transmission throughput based on the physical layer transmission rate, a transmission packet size, and a transmission reservation allocation comprises:
the transmitter accessing the estimated transmission throughput from a look up table.

5. The method of claim 2, wherein the transmitter calculating an estimated transmission throughput based on the physical layer transmission rate, a transmission packet size, and a transmission reservation allocation comprises:
the transmitter calculating the estimated transmission throughput using a predetermined function.

6. The method of claim 1, further comprising the transmitter buffering the encoded data before transmission.

7. The method of claim 6, further comprising the transmitter detecting if a buffering queuing delay exceeds a first predetermined threshold, and the transmitter adaptively decreasing the data rate of the encoded data if the buffering queuing delay exceeds the first predetermined threshold.

8. The method of claim 7, further comprising varying the first predetermined threshold based on at least one of a stability and accuracy of the estimated transmission throughput.

9. The method of claim 6, further comprising the transmitter detecting if a buffering queuing delay falls below a second predetermined threshold, and the transmitter adaptively increasing the data rate of the encoded data to the estimated transmission throughput if the buffering queuing delay falls below the second predetermined threshold.

10. The method of claim 9, further comprising varying the second predetermined threshold based on at least one of a stability and accuracy of the estimated transmission throughput.

11. The method of claim 1, further comprising the transmitter re-determining the physical layer transmission rate over time.

12. The method of claim 11, further comprising the transmitter determining the physical layer transmission rate once per a UWB frame.

13. The method of claim 2, further comprising updating the transmission reservation allocation over time.

14. The method of claim 6, further comprising the transmitter adaptively updating the data rate of the encoded data based on an average of the queuing delay of the encoded data.

15. The method of claim 1, wherein the encoded data comprises video data, and the data rate of the video data is at least partially adjusted by a selection of compression technique.

16. The method of claim 15, further comprising selecting the compression technique of the video data based on at least one of a variability of the transmission link quality, an accuracy of estimates of transmission link quality, a speed at which the transmission link quality is determined, and a number of devices which are sharing a channel.

17. The method of claim 1, further comprising:
determining a plurality of physical layer transmission rates based on transmission link qualities of a plurality of links;
estimating a plurality of transmission throughputs that can be transmitted over a plurality of links ensuring a level of Quality of Service (QOS) requirements;
the transmitter adjusting the data rate of the encoded data based on the estimated plurality of transmission throughputs.

18. The method of claim 1, further comprising:
determining a plurality of physical layer transmission rates based on transmission link qualities of a plurality of links;
estimating a plurality of transmission throughputs that can be transmitted over a plurality of links ensuring a level of Quality of Service (QOS) requirements
the transmitter adjusting data rates of the encoded data based on the estimated plurality of transmission throughputs.

19. The method of claim 17, wherein the plurality of links comprise wireless links between the transmitter and devices a single hop from the transmitter.

20. The method of claim 17, wherein the plurality of links comprise wireless links between the transmitter and devices multiple hops from the transmitter.

21. The method of claim 1, further comprising adaptively adjusting the data rate of the encoded data based upon a queue size of encoded data buffering.

22. A method of setting a data rate of encoded data of a transmitter, comprising:
determining a physical layer transmission rate based on a transmission link quality of a link;
adjusting the data rate of the encoded data based on the physical layer transmission rate, a transmission packet size, and a transmission reservation allocation.

23. A transmitter comprising:
means for determining a physical layer transmission rate based on a transmission link quality of a link;
means for estimating a transmission throughput that can be transmitted over the link ensuring a level of Quality of Service (QOS) requirement;
means for adjusting the data rate of the encoded data based on the estimated transmission throughput.

24. A method of setting a data rate of encoded video data for a UWB wireless transmitter, comprising:
determining a physical layer transmission rate based on a transmission link quality of a link;
estimating a transmission throughput that can be transmitted over the link ensuring a level of Quality of Service (QOS) requirement;
the UWB wireless transmitter adjusting the data rate of the encoded video data based on the estimated transmission throughput.
